(19) United States
(12) Patent Application Publication
(10) Pub. No.: US 2026/0350153 A1
(43) Pub. Date: Nov. 5, 2026

(54) System and method for modifying a computing environment using metamorphic computing

(71) Applicant: Bank of America Corporation, Charlotte, NC (US)

(72) Inventors: Jesus Duarte, Dallas, TX (US); Arpit Tulsyan, Delhi (IN); David Eugenio Martinez Garza, The Colony, TX (US); Saurabh Gupta, Dwarka (IN); Soma Upadhyay, Lewisville, TX (US); Megha Kandrigal, MCKINNEY, TX (US); Jose Daniel Valdez, Richardson, TX (US); Albert H. Hansen, Mooresville, NC (US); Mauli Saluram Kharat, Jalna (IN); Subburathinam Krishnan, Chennai (IN); Sandeep Gandhi, Waxhaw, NC (US)

(21) Appl. No.: 19/198,587

(22) Filed: May 5, 2025

(51) Int. Cl. G06F 21/55

(52) U.S. Cl. CPC G06F 21/554; G06F 2221/034

(57) ABSTRACT

In response to determining that a security breach has occurred in relation to processing of a data interaction, interaction data associated with the data interaction is input to a trained artificial intelligence (AI) model based on which the AI model determines that a first interaction algorithm configured to process the data interaction is breached. In response, the AI model selects and outputs a first alternative interaction algorithm that has a same or similar functionality as the first interaction algorithm. The runtime environment of the data interaction is altered in real time by switching to process the data interaction based on the first alternative interaction algorithm instead of the first interaction algorithm.

### TECHNICAL FIELD

The present disclosure relates generally to network security, and more specifically to a system and method for modifying a computing environment using metamorphic computing.

### BACKGROUND

In conventional systems, a cyber-attack on a computing system that results in a data breach is detected after damage to computing systems has occurred because of the data breach. In one example, a data breach may include unauthorized installing of malicious software code at a computing device (e.g., data server) that performs malicious activities to disrupt an operation of the computing device by creating unwanted files to slow down the speed and performance of the computing device, corrupting files, or crashing some software or executable applications so that they cannot be executed. In another example, a data breach may include access to sensitive data, such as personal information without authorization. In another example, a data breach may exfiltrate data by transmitting confidential data to unauthorized devices. Conventional systems lack the capability to detect data breaches and apply security measures that avoid or prevent the data breach from causing damage to computing systems.

### SUMMARY

The system and method implemented by the system as disclosed in the present disclosure provide technical solutions to the technical problems discussed above by proactively detecting data breaches and implementing remediation methods in real time to avoid damage (e.g., data theft, compromised computing performance, device failure etc.) to computing systems.

Computing systems (e.g., computing nodes 104) that store, process, or handle sensitive data in some manner are prone to cyber-attacks or data breaches in which a hacker gains unauthorized access to the computing systems and data stored on the computing systems. The term “cyber-attack” is often used interchangeably with the terms “data breach” and “security breach” and refers to any security incident in which unauthorized parties access computing systems and sensitive or confidential information, including but not limited to, Non-Public Information (NPI), Personal Identification Information (PII), Production Information, or any other data that is designated as sensitive data. In one example, a data breach may include unauthorized installing of malicious software code (e.g., malware) at a computing device (e.g., data server), wherein the malicious software is configured to perform malicious activities to disrupt an operation of the computing device, for example, by creating unwanted files to slow down the speed and performance of the computing device, corrupting files, or crashing some software or executable applications so that they cannot be executed.

Malware can infect many types of devices, including cell phones, computers, tables, and smart televisions. It usually spreads by duplicating itself and hiding in a device's data files. A malware attack often results in compromised computing performance by causing slow processor performance, browser redirects, frequent infection warnings, frequent pop-up ads, problems starting up and shutting down a computing node, sudden loss of memory disk space, repeated system crashes and freezes, disabled security features, changes in file name and sizes, programs opening and closing themselves, or a combination thereof. In some cases, a malware locks up networks and computing nodes making them unusable. In another example, a data breach may include access to sensitive data, such as personal information without authorization. In another example, a data breach may exfiltrate data by transmitting confidential data to unauthorized devices. In some cases, the stolen data may be used to perform other unauthorized data interactions within the computing infrastructure and to gain access to other computing nodes.

Conventional systems generally implement a reactive approach to detecting and remediating data breaches. For example, conventional systems lack the capability to detect data breaches when they are actively taking place. Further, conventional systems cannot apply security measures in real-time that avoid or prevent the data breach from causing damage (e.g., data theft, compromised computing performance, device failure etc.) to computing systems.

Embodiments of the present disclosure provide several practical applications and technical advantages that provide solutions to the problems discussed above in relation to conventional computing systems and networks.

For example, the disclosed system and methods provide the practical application of proactively detecting a data breach within the computing infrastructure in real time or near real time as the data breach is taking place and apply one or more remediation methods in real time to avoid damage (e.g., data theft, compromised computing performance, device failure etc.) or further damage to the computing infrastructure because of the data breach. As described in embodiments of the present disclosure, the disclosed techniques for detecting data breaches as they are occurring in a computing system include monitoring real time performance data of the computing system and determining that a data breach has occurred or actively occurring in response to detecting known indicators of a data breach. The disclosed techniques for applying remediation methods include leveraging metamorphic computing technology to dynamically apply metamorphic transformations to the computing infrastructure or portions thereof in real time, wherein the metamorphic transformations include real-time transformations to an interaction algorithm associated with a data interaction, real-time data transformations to sensitive data that has been or is under imminent threat of breach, and network topology transformations of a hardware network topology and/or logical network topology used for processing a data interaction that has been breached.

The idea here is that dynamically altering configuration of computing systems using metamorphic computing does not allow a hacker sufficient time to detect and use vulnerabilities of the computing system. Before a hacker has had a chance to analyze a current execution/runtime environment (e.g., a current interaction algorithm, network topology, sensitive data etc.) and use security vulnerabilities of the runtime environment, interaction manager changes the execution/runtime environment (e.g., changes the interaction algorithm, changes the network topology, transforms the sensitive data or combination thereof). This changing configuration of the runtime environment makes it almost impossible for a hacker to breach the computing system.

Thus, unlike conventional systems where a data breach is detected after damage to computing systems has taken place, the disclosed system and methods proactively detect a data breach as they are taking place and implement remediation methods in real time that stop damage or further damage from occurring because of the data breach. This avoids a bad actor from gaining access to a computing system (e.g., data server) and from installing malware at the data server. By avoiding a malware attack at the data server, the disclosed system and method avoid damage to the data server that may otherwise occur due to malware installed at the data server. For example, avoiding a malware attack may avoid several types of damage typically caused by a malware attack including, but not limited to, compromised computing performance including slow processor performance, browser redirects, frequent infection warnings, frequent pop-up ads, problems starting up and shutting down a computing node, sudden loss of memory disk space, repeated system crashes and freezes, disabled security features, changes in file name and sizes, programs opening and closing themselves, or a combination thereof. Thus, by avoiding or preventing security breaches, the disclosed system and method causes faster and more efficient performance of computing systems which otherwise may have slowed down by a malware attack. Further, by avoiding or preventing system crashes and freezes because of security breaches, the disclosed system and method increase system uptime, thus further improving performance of the computing system.

In addition, by not allowing unauthorized access to a breached data server, the disclosed system and method avoid or prevent a bad actor from gaining unauthorized access to other computing nodes and systems that are communicatively coupled to the breached data server, and thus avoid damage to those other computing nodes and systems.

Thus, the disclosed system and method generally improve the technology associated with data security of computing networks.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure; and

FIG. 2 illustrates an example system for implementing metamorphic transformations in a computing infrastructure, in accordance with certain embodiments of the present disclosure.

### DETAILED DESCRIPTION

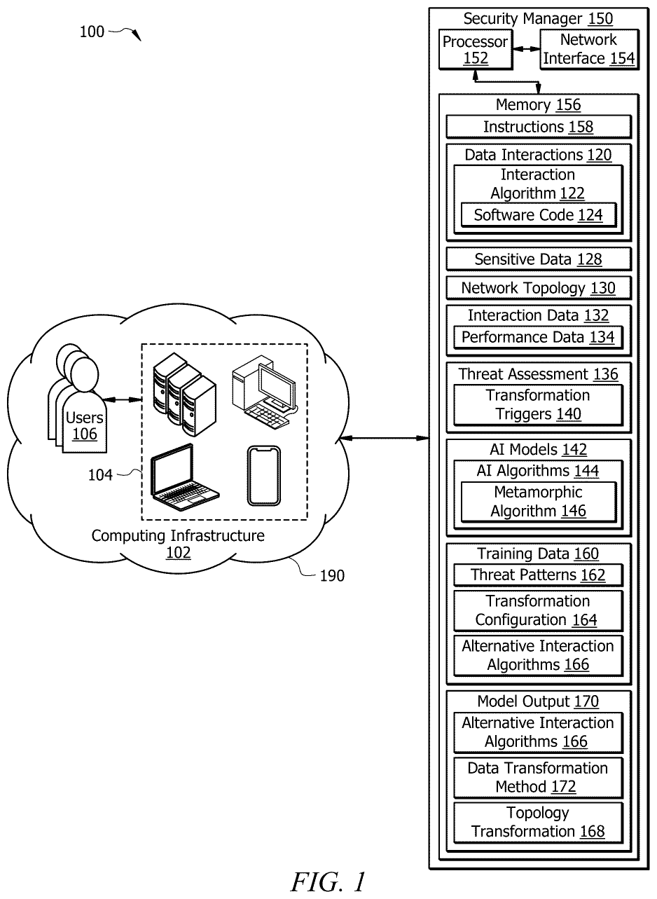

FIG. 1 is a schematic diagram of a system 100, in accordance with certain aspects of the present disclosure. As shown, system 100 includes a computing infrastructure 102 connected to a network 190. Computing infrastructure 102 may include a plurality of hardware and software components. The hardware components may include, but are not limited to, computing nodes 104 such as desktop computers, smartphones, tablet computers, laptop computers, data servers and data centers, mainframe computers, virtual reality (VR) headsets, augmented reality (AR) glasses and other hardware devices such as printers, routers, hubs, switches, and memory all connected to the network 190. Software components may include software applications that are run by one or more of the computing nodes 104 including, but not limited to, operating systems, user interface applications, third party software, database management software, service management software, mainframe software, metaverse software, AI tools and other customized software programs (e.g., security manager 150) implementing particular functionalities. For example, software code relating to one or more software applications may be stored in a memory device and one or more processors (e.g., belonging to one or more computing nodes 104) may execute the software code to implement respective functionalities. An example software application run by one or more computing nodes 104 of the computing infrastructure 102 may include the security manager 150. In one embodiment, at least a portion of the computing infrastructure 102 may be representative of an Information Technology (IT) infrastructure of an organization.

One or more of the computing nodes 104 may be operated by a user 106. In this context, a computing node 104 operated by a user may be referred to as a user device. For example, a computing node 104 may provide a user interface using which a user 106 may operate the computing node 104 to perform data interactions within the computing infrastructure 102. The term “computing node 104” may be replaced by “user device” in this disclosure when the computing node 104 is operated by a user 106.

One or more computing nodes 104 of the computing infrastructure 102 may be representative of a computing system which hosts software applications that may be installed and run locally or may be used to access software applications running on a server. The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes 104 may be representative of a server running one or more software applications to implement respective functionality as described below. In certain embodiments, one or more of the computing nodes 104 may run a thin client software application where the processing is directed by the thin client but largely performed by a central entity such as a server (not shown).

Network 190, in general, may be a wide area network (WAN), a personal area network (PAN), a cellular network, or any other technology that allows devices to communicate electronically with other devices. In one or more embodiments, network 190 may be the Internet.

As described above, a user 106 may operate a computing node 104 (e.g., a personal computer) to perform a data interaction within the computing infrastructure 102. For example, a user 106 may operate a user device (e.g., one of the computing nodes 104) to perform a particular data interaction within the computing infrastructure 102. Data interactions that may be performed in the computing infrastructure 102 may include accessing data stored in a memory device (e.g., database or server) of the computing infrastructure 102, processing data by a processing server of the computing infrastructure 102, transmission of data between computing nodes 104 of the computing infrastructure 102, or a combination thereof. In one example, a data interaction may include a user 106 logging into a user profile (e.g., a social media profile, a content streaming profile, an email profile etc.) to gain access to data (e.g., social media data feed, video content, emails etc.) stored on a respective data server. In one example, a data interaction may include a user 106 requesting a piece of data stored on a database or server (e.g., a computing node 104) of the computing infrastructure 102 and receiving the requested data at a user device (e.g., another computing node 104). For example, the user 106 may use a webmail application running on the user device to request and receive email data from an email server. In another example, a data interaction requested by a user 106 using a user device may include data transmission from a first computing node 104 to a second computing node 104 of the computing infrastructure 102. For example, sending an email by a first user to a second user may include transmission of email data from a first email server associated with the first user to a second email server associated with the second user. Performing a data interaction within the computing infrastructure 102 may include accessing, processing, and or transmission of sensitive data including, but not limited to, Non-Public Information (NPI), Personal Identification Information (PII), Production Information, or any other data that is designated as sensitive data.

Often computing systems (e.g., computing nodes 104) that store, process, or handle sensitive data in some manner are prone to cyber-attacks or data breaches in which a hacker gains unauthorized access to the computing systems and data stored on the computing systems. The term “cyber-attack” is often used interchangeably with the term “data breach” and refers to any security incident in which unauthorized parties access computing systems and sensitive or confidential information, including but not limited to, Non-Public Information (NPI), Personal Identification Information (PII), Production Information, or any other data that is designated as sensitive data. In one example, a data breach may include unauthorized installing of malicious software code (e.g., malware) at a computing device (e.g., data server), wherein the malicious software is configured to perform malicious activities to disrupt an operation of the computing device, for example, by creating unwanted files to slow down the speed and performance of the computing device, corrupting files, or crashing some software or executable applications so that they cannot be executed. A malware can infect many types of devices, including cell phones, computers, tables, and smart televisions. It usually spreads by duplicating itself and hiding in a device's data files. A malware attack often results in compromised computing performance by causing slow processor performance, browser redirects, frequent infection warnings, frequent pop-up ads, problems starting up and shutting down a computing node, sudden loss of memory disk space, repeated system crashes and freezes, disabled security features, changes in file name and sizes, programs opening and closing themselves, or a combination thereof. In some cases, a malware locks up networks and computing nodes making them unusable. In another example, a data breach may include access to sensitive data, such as personal information without authorization. In another example, a data breach may exfiltrate data by transmitting confidential data to unauthorized devices. In some cases, the stolen data may be used to perform other unauthorized data interactions within the computing infrastructure and to gain access to other computing nodes.

Bad actors use several techniques to gain unauthorized access to computing systems. For example, a bad actor may engage in a phishing attack to steal sensitive user information. A phishing attack may include the bad actor sending a text message to a user purporting to be from a reputable organization in order to induce the user to reveal personal information such as passwords to user profiles. In one example, a bad actor may send a text message to a user's smart phone purporting to be from an email provider of the user. The text message may include a link to a webpage that looks like a login screen of the email provider. Upon, clicking the link from the text message, the user is re-directed to the webpage where the user is induced to enter a username and password of the user's email profile. This allows the bad actor to gain access to the user's emails and use sensitive data included in the user's emails to gain access to other computing systems. For example, the bad actor may gain access to an email that includes membership details of a video streaming service, which allows the bad actor to gain access to a streaming server.

Bad actors may use several security vulnerabilities associated with a computing network (e.g., computing infrastructure 102) and/or computing nodes 104 of the computing network to gain unauthorized access to computing nodes, systems and data hosted/stored on those nodes and systems. Security vulnerabilities in a computing system can stem from various sources, ranging from hardware weaknesses to software flaws. Some common security vulnerabilities that make a system susceptible to security or data breaches include, but are not limited to, software (e.g., software algorithms) having insufficient security features, insufficient or delayed monitoring, weak authentication mechanisms, insufficient access controls, insecure network configuration, insecure Application Process Interfaces (APIs), unsecured endpoints, improper configuration of cloud services, and supply chain attacks. For example, running outdated software or operating systems with unpatched security vulnerabilities is one of the primary causes of security or data breaches. In another example, weak passwords, poor password policies, or lack of multi-factor authentication (MFA) make it easier for attackers to gain unauthorized access. In another example, lack of proper access control mechanisms (e.g., role-based access control) can give unauthorized users elevated privileges. In another example, poor network security practices, such as open ports, weak firewalls, and poorly configured VPNs, make systems vulnerable to attacks. In another example, a system without proper logging and monitoring may not detect or respond to malicious activities in a timely manner. In another example, APIs (Application Programming Interfaces) that are improperly secured can expose sensitive data or allow unauthorized access to system resources. In another example, devices like mobile phones, laptops, and IoT devices that are connected to the network can become an entry point for attackers if they are not secured. In another example, attackers target third-party vendors or software providers to compromise their products and introduce malicious code into trusted systems.

Once the bad actor gains access to a data server using any of these methods, the bad actor may install malware at the data server to compromise the performance of the data server and/or steal sensitive data stored at the data server.

Conventional systems generally implement a reactive approach to detecting and remediating data breaches. For example, conventional systems lack the capability to detect data breaches when they are actively taking place. Further, conventional systems cannot apply security measures in real-time that avoid or prevent the data breach from causing damage (e.g., data theft, compromised computing performance, device failure etc.) to computing systems.

Embodiments of the present disclosure discuss improved techniques to proactively detect a data breach within the computing infrastructure 102 and apply one or more remediation methods in real time to avoid damage or further damage to the computing infrastructure 102 because of the data breach. As described in embodiments of the present disclosure, the disclosed techniques for applying remediation methods include leveraging metamorphic computing technology to apply metamorphic transformations to the computing infrastructure 102 or portions thereof in real time, wherein the metamorphic transformations include real-time transformations to an interaction algorithm 122 associated with a data interaction 120, real-time data transformations to sensitive data 128 that has been or is under imminent threat of breach, and network topology transformations of a hardware network topology and/or logical network topology used for processing a data interaction 120 that has been breached.

At least a portion of the computing infrastructure 102 (e.g., one or more computing nodes 104) may implement a security manager 150 which may be configured to implement techniques for proactively detecting a data breach in a computing network (e.g., computing infrastructure 102) and implementing remediation measures (e.g., metamorphic transformations) to avoid damage from the data breach. The security manager 150 includes a processor 152, a memory 156, and a network interface 154. The security manager 150 may be configured as shown in FIG. 1 or in any other suitable configuration.

The processor 152 includes one or more processors operably coupled to the memory 156. The processor 152 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 152 may be a programmable logic device, a microcontroller, a microprocessor, or any suitable combination of the preceding. The processor 152 is communicatively coupled to and in signal communication with the memory 156. The one or more processors are configured to process data and may be implemented in hardware or software. For example, the processor 152 may be 8-bit, 16-bit, 32-bit, 64-bit or of any other suitable architecture. The processor 152 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

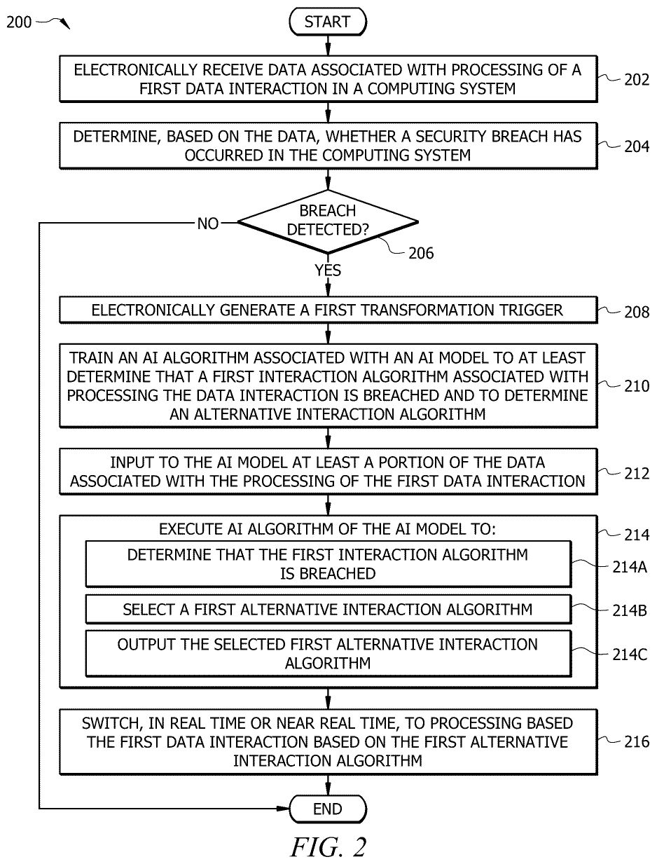

The one or more processors are configured to implement various instructions, such as software instructions. For example, the one or more processors are configured to execute instructions 158 to implement the security manager 150. In this way, processor 152 may be a special-purpose computer designed to implement the functions disclosed herein. In one or more embodiments, the security manager 150 is implemented using logic units, FPGAs, ASICs, DSPs, or any other suitable hardware. The security manager 150 is configured to operate as described with reference to FIGS. 1 and 2. For example, the processor 152 may be configured to perform at least a portion of method 200 as described with reference to FIG. 2 respectively.

The memory 156 includes a non-transitory computer-readable medium such as one or more disks, tape drives, or solid-state drives, and may be used as an over-flow data storage device, to store programs when such programs are selected for execution, and to store instructions and data that are read during program execution. The memory 156 may be volatile or non-volatile and may include a read-only memory (ROM), random-access memory (RAM), ternary content-addressable memory (TCAM), dynamic random-access memory (DRAM), and static random-access memory (SRAM).

The memory 156 is operable to store the instructions 158, information relating to data interactions 120 including interaction algorithms 122, software code 124 and smart contracts 126, sensitive data 128, network topologies 130, interaction data 132 (including hardware and software performance data 134), information relating to threat assessment 136 (including threat level 138 and transformation triggers 140), AI models 142 (including AI algorithms 144 used by respective AI models 142), training data 160 (including threat patterns 162, transformation configurations 164, and alternative interaction algorithms 166), model output 170 (including alternative interaction algorithms 166, code transformations 168, data transformation methods 172, and topology transformations 168), and any other data needed to performed operations of the security manager 150 as described in embodiments of the present disclosure. The instructions 158 may include any suitable set of instructions, logic, rules, or code operable to execute the security manager 150.

The network interface 154 is configured to enable wired and/or wireless communications. The network interface 154 is configured to communicate data between the security manager 150 and other devices, systems, or domains (e.g., computing nodes 104). For example, the network interface 154 may include a Wi-Fi interface, a LAN interface, a WAN interface, a modem, a switch, or a router. The processor 152 is configured to send and receive data using the network interface 154. The network interface 154 may be configured to use any suitable type of communication protocol as would be appreciated by one of ordinary skill in the art.

It may be noted that each of the computing nodes 104 may be implemented like the security manager 150 shown in FIG. 1. For example, each of the computing nodes 104 may have a respective processor and a memory that stores data and instructions to perform a respective functionality of the computing node 104.

Security manager 150 may be configured to proactively detect a data breach within the computing infrastructure 102 and apply one or more remediation methods in real time to avoid damage or further damage to the computing infrastructure 102 because of the data breach. As described in more detail below, security manager 150 may be configured to leverage metamorphic computing to avoid data breaches or potential data breaches from causing damage to computing systems and/or avoid data theft. In the context of the present disclosure, metamorphic computing refers to a computational paradigm inspired by the concept of metamorphosis, which involves systems that can change their structure or behavior dynamically. As further described in detail, in response to detecting a data breach or a potential data breach, interaction manager 150 may be configured to dynamically alter configuration of the computing infrastructure 102 or portions thereof in real time. For example, interaction manager 150 may be configured to dynamically apply metamorphic transformations to the computing infrastructure 102 or portions thereof in real time, wherein the metamorphic transformations include real-time transformations to an interaction algorithm 122 associated with a data interaction 120, real-time data transformations to sensitive data 128 that has been or is under imminent threat of breach, and network topology transformations of a hardware network topology and/or logical network topology used for processing a data interaction 120 that has been breached. The idea here is that dynamically altering configuration of computing systems does not allow a hacker sufficient time to detect and use vulnerabilities of the computing system. Before a hacker has had a chance to analyze a current execution/runtime environment (e.g., a current interaction algorithm 122, network topology 130, sensitive data 128 etc.) and use security vulnerabilities of the runtime environment, interaction manager 150 changes the execution/runtime environment (e.g., changes the interaction algorithm 122, changes the network topology 130, transforms the sensitive data 128 or combination thereof). This changing configuration of the runtime environment makes it almost impossible for a hacker to breach the computing system.

Security manager 150 may be configured to detect that a data breach has occurred in relation to a data interaction 120 being processed in the computing infrastructure 102 or a portion thereof, based on monitoring performance of the computing infrastructure 102 or the potion thereof. In this context, security manager 150 may be configured to monitor several metrics (e.g., interaction data 132) associated with processing of a data interaction 120 in the computing infrastructure 102 to determine whether a data breach has occurred in relation to the data interaction 120. In this context, security manager 150 may have access to interaction data 132 associated with data interactions 120 being processed by computing nodes 104 of the computing infrastructure 102. Interaction data 132 associated with a particular data interaction 120 may include performance data 134 indicating performance of various hardware components (e.g., computing nodes such as servers, user devices, network devices, etc.) and software components (e.g., operating systems, customized software etc.) used to process the particular data interaction 120. Performance data 134 may include several metrics that indicate performance of the hardware and software components involved in processing the data interaction 120. Example performance data 134 may include, but is not limited to, CPU utilization, memory utilization, disk input/output (I/O), throughput, latency, response time, system load, power consumption, error rate, and heat dissipation.

Additionally, or alternatively, interaction data 132 may include an interaction log associated with each data interaction 120 that includes a plurality of interaction parameters recording information relating to the data interaction 120, wherein the interaction parameters may include, but are not limited to, identity of a user 106 or computing node 104 that initiated the data interaction, authorization credentials (e.g., username, password etc.) of the user 106, a type of the data interaction (e.g., data access, data transfer etc.), a device ID of a computing node (e.g., user device) that was used to initiate the data interaction, an internet protocol (IP) address of the computing node, a network ID of the network (e.g., Local Area Network (LAN)) to which the computing node is connected to, device ID of a network router using which the computing node is communicating with the network 190, a device ID and IP address of the computing node that is being accessed by the user device, information (e.g., IP address) relating to intermediate computing nodes that are involved in performing the data interaction 120, and any other information relating to the data interaction 120. In some embodiments, an interaction log is automatically generated (e.g., by a designated computing node 104 within the computing infrastructure 102) for each data interaction performed in the computing infrastructure 102. The security manager 150 has access in real time to interaction logs associated with data interactions being conducted in the computing infrastructure 102 or shortly after being conducted in the computing infrastructure.

Security manager 150 may be configured to perform a threat assessment 136 for each data interaction 120 being processed in the computing infrastructure 102 to at least determine, in real-time, whether a data breach has occurred in relation to a data interaction 120 being processed in the computing infrastructure 102. The threat assessment 136 performed by security manager 150 may include analyzing at least the interaction data 132 associated with a data interaction 120 to determine whether a data breach has occurred in relation to the data interaction 120. As part of the threat assessment 136, security manager 150 may be configured to identify certain indicators of a data breach or a potential data breach in the interaction data 132 associated with a data interaction 120. In one example, unexplained high CPU usage, high memory usage and/or slow response times may be indicative of malicious processes running on a computing node 104 (e.g., cryptocurrency mining, malware, or exploitation of system resources). In such a case, security manager 150 may be configured to determine that a data breach has occurred in relation to the data interaction in response to detecting unexpectedly high (e.g., higher than an expected threshold) CPU utilization, unexpectedly high memory utilization, unexpectedly high node response times or a combination thereof. In another example, when data is received from an unexpected/unauthorized computing node or being sent to an unauthorized computing node, this may indicate that a bad actor is attempting to impersonate an authorized computing system, also known as IP spoofing. In such cases, security manager 150 may be configured to determine that a data breach has occurred in relation to the data interaction in response to detecting one or more computing nodes 104 with unexpected/unauthorized IP addresses involved in the processing of the data interaction 120 (e.g., transmitting/receiving data).

It may be noted that the above two examples is not an exhaustive list and that there are many other indicators of a security/data breach based on detection of which security manager 150 may determine that a security breach has occurred. Other example indicators of a security breach may include, but are not limited to, unusual network traffic (e.g., unexpected traffic spikes), unauthorized access attempts (e.g., failed login attempts), unexpected file modifications, known malware signatures, unexpected alteration in system configuration, and changes to system clock or time zones. Interaction manager 150 may determine that a security breach has occurred in relation to a data interaction 120 being processed in the computing infrastructure 102 in response to detecting any one or more of these indicators in the interaction data 132.

In one embodiment, security manager 150 may be configured to employ a trained Artificial Intelligence (AI) model 142 to determine security breaches in the computing infrastructure 102. An artificial intelligence (AI) model (e.g., AI models 142 shown in FIG. 1) is a mathematical framework that learns patterns from data in order to make predictions or decisions without being explicitly programmed for every task. The model is designed to recognize relationships or patterns within the input data (features) and use this learned information to make predictions on new, unseen data. The core idea is that the AI model “learns” from historical data (training data 160) and generalizes that learning to make accurate predictions on test data or real-world applications. Depending on the task, AI models can be classified into several categories. For example, an AI algorithm associated with a supervised AI model is trained on labeled data (e.g., inputs paired with known outputs) to learn the mapping between inputs and outputs. An AI algorithm associated with an unsupervised AI learning model is trained on unlabeled data to find hidden patterns or groupings (e.g., clustering or dimensionality reduction). A reinforcement AI model learns by interacting with an environment and receiving feedback based on actions taken.

AI models 142 rely on various AI algorithms 144 to learn from data (e.g., training data 160) and make predictions, classifications, or decisions. The choice of algorithm depends on the type of task (supervised, unsupervised, reinforcement learning), the nature of the data, and the specific problem being solved. Common AI algorithms 144 used by AI models 142 include, but are not limited to, supervised learning algorithms such as regression and classification algorithms, unsupervised learning algorithms such as clustering algorithms and dimensionality reduction algorithms, reinforcement learning algorithms, ensemble learning algorithms, and deep learning algorithms.

In order to detect security/data breaches in relation to data interactions 120 being performed in the computing infrastructure 102, security manager 150 may train an AI algorithm 144 associated with an AI model 142 to detect the data breaches based on real-time interaction data 132 associated with the processing of the data interactions 120. Training data 160 used to train the AI algorithm 144 associated with the AI model 142 may include any one or more of the known indicators described above of a data breach. For example, training data 160 may include higher than threshold CPU utilization, memory utilization, response time, or combination thereof translates to a data breach. Once the AI algorithm 144 has been trained based on the training data 160 including the known indicators of a data breach, security manager 150 may input to the trained AI model 142, real-time interaction data 132 associated with data interactions 120 being processed in the computing infrastructure 102. The trained AI model 142 may extract from the interaction data 132 of each data interaction 120, known indicators of a data breach. If one or more of the known indicators of data breach are found in the interaction data 132, AI model 142 may output an indication that a data breach has occurred in relation to the respective data interaction 120.

Once a determination of data breach has been made in relation to a data interaction 120, security manager 150 may be configured to generate a transformation trigger 140 to initiate metamorphic transformation of the runtime/execution environment of the data interaction. The runtime environment in a computing system generally refers to the collection of hardware, software, and resources that are employed to process a task (e.g., data interaction 120). Each data interaction 120 is generally associated with a runtime environment including a combination of hardware, software, and other resources used to process the data interaction 120. A runtime environment associated with a data interaction 120 may include an interaction algorithm 122 associated with the data interaction 120, wherein the interaction algorithm defines a sequence of tasks (e.g., processes) to be performed to complete the data interaction 120. Each interaction algorithm 122 is implemented by a piece of software code 124. Additionally, or alternatively, runtime environment associated with a data interaction 120 may include a network topology 130 used to process the data interaction 120. Network topology 130 generally refers to physical and logical arrangements of network components in a computing network (e.g., computing infrastructure 102). These network components may include physical hardware components such as servers, databases, routers, switches and other computing nodes 104) or software modules and components. The network topology 130 associated with a particular data interaction 120 defines how data flows via hardware and software components when implementing a respective interaction algorithm 122 to process the particular data interaction 120. For example, a network topology 130 may define which computing node 104 (e.g., server) and software component performs which tasks in the interaction algorithm 122. Additionally, or alternatively, runtime environment associated with a data interaction 120 may include data accessed, received and/or transmitted as part of processing the data interaction. This data may include sensitive data 128 including, but not limited to, Non-Public Information (NPI), Personal Identification Information (PII), Production Information, or any other data that is designated as sensitive data128.

In response to detecting that a transformation trigger 140 has been generated in relation to a data interaction, security manager 150 may be configured to dynamically transform (e.g., change, adjust and/or replace), in real time, any portion of the runtime environment associated with the data interaction 120 including the interaction algorithm 122, network topology 130, sensitive data 128, or combination thereof. In this context, security manager 150 may be configured to employ a trained AI model 142 to determine which one or more components (e.g., interaction algorithm 122, network topology 130, sensitive data 128) of the runtime environment is to be metamorphically transformed and how the metamorphic transformation is to be implemented. In one embodiment, the AI model 142 may employ a metamorphic algorithm 146 to make these determinations.

In this context, security manager 150 may be configured to train the metamorphic algorithm 146 of the AI model 142 to detect which one or more components (e.g., interaction algorithm 122, network topology 130, sensitive data 128) of the runtime environment has been compromised. For example, training data 160 used to train the metamorphic algorithm 146 of the AI model 142 includes known threat patterns 162 that indicate which component components (e.g., interaction algorithm 122, network topology 130, sensitive data 128) of the runtime environment has been compromised. In one embodiment, the known threat patterns 162 used to train the metamorphic algorithm 146 of the AI model 142 include known threat patterns 162 that indicate that the interaction algorithm 122 associated with the data interaction 120 has been compromised or breached. This essentially may mean that a bad actor has found a vulnerability in the interaction algorithm 122 and is attempting to breach or has already breached the computing network using this vulnerability. Example, known threat patterns 162 that indicate that the interaction algorithm 122 associated with the data interaction 120 has been compromised include, but are not limited to, incorrect or unexpected results, anomalies in log entries, unusual access/login attempts, unauthorized data alteration, unexpected change in source code (e.g., software code 124) of the interaction algorithm 122, and antivirus intrusion alerts. Once the metamorphic algorithm 146 of the AI model 142 is trained using the known threat patterns 162, security manager 150 may input to the trained AI model 142 real-time interaction data 132 associated with a data interaction 120 actively processing in the computing infrastructure 102. In one embodiment, security manager 150 may initiate this process in response to detecting that the transformation trigger 140 has been generated. The trained model 142 may search the interaction data 132 for the known threat patterns 162 that indicate that the interaction algorithm 122 associated with the data interaction 120 has been compromised. Upon identifying one or more of the known threat patterns 162, AI model 142 may determine that the interaction algorithm 122 associated with the data interaction 120 has been compromised.

In additional or alternative embodiments, the known threat patterns 162 used to train metamorphic algorithm 146 of the AI model 142 include known threat patterns 162 that indicate that the network topology 130 associated with processing the data interaction 120 has been compromised. A compromised network topology 130 may include a breached computing node 104 (e.g., server) that is involved in processing the data interaction 120. Example known threat patterns 162 that indicate that the network topology 130 associated with processing the data interaction 120 has been compromised include, but are not limited to, unexpectedly high (e.g., higher than an expected threshold) CPU utilization, unexpectedly high memory utilization, unexpectedly high node response times, unexpected/unauthorized IP addresses involved in the processing of the data interaction 120 (e.g., transmitting/receiving data) or a combination thereof. When the real-time interaction data 132 associated with a data interaction 120 is input to the trained AI model 142, the trained model 142 may search the interaction data 132 for the known threat patterns 162 that indicate that the network topology 130 (e.g., one or more computing nodes 104) associated with processing the data interaction 120 has been compromised. Upon identifying one or more of the known threat patterns 162, AI model 142 may determine that the network topology 130 (e.g., one or more computing nodes 104) associated with the data interaction 120 has been compromised.

In additional or alternative embodiments, the known threat patterns 162 used to train the metamorphic algorithm 146 of the AI model 142 include known threat patterns 162 that indicate that sensitive data 128 stored at one or more computing nodes 104 has been compromised. This means that a bad actor has somehow gained access to the sensitive data 128. Example known threat patterns 162 that indicate that sensitive data 128 stored at one or more computing nodes 104 has been compromised include, but are not limited to, failed login attempts, logins from unusual locations or device, use of unauthorized (e.g., stolen) login credentials, unauthorized access to restricted data files, unexpected and/or unauthorized modification to data files, alerts from security systems, detection of malware or ransomware, unusual file extensions or file modifications, unusual database queries, and use of uncommon data transfer protocols to exfiltrate data. When the real-time interaction data 132 associated with a data interaction 120 is input to the trained AI model 142, the trained model 142 may search the interaction data 132 for the known threat patterns 162 that indicate that sensitive data 128 has been compromised. Upon identifying one or more of the known threat patterns 162, AI model 142 may determine that the sensitive data 128 has been compromised.

Once the AI model 142 identifies that one or more components (e.g., interaction algorithm 122, network topology 130, sensitive data 128) of the runtime environment associated with the data interaction 120 has been compromised, the AI model 142 may determine how to metamorphically transform the one or more components to stop the data breach from progressing and avoid further damage as a result of the data breach. In this context, in an additional or alternative embodiment, security manager 150 may be configured to train the metamorphic algorithm 146 of the AI model 142 to determine how one or more components (e.g., interaction algorithm 122, network topology 130, sensitive data 128) of the runtime environment is to be metamorphically transformed. Training data 160 used to train the metamorphic algorithm 146 of the AI model 142 for this purpose may include a transformation configuration 164 associated with each known threat pattern 162, wherein each transformation configuration 164 defines how one or more components (e.g., interaction algorithm 122, network topology 130, sensitive data 128) of the runtime environment are to be transformed. For example, a transformation configuration 164 associated with a known threat pattern 162 indicating a compromised interaction algorithm 122 may define that the interaction algorithm 122 is to be modified or replaced with an alternative interaction algorithm 166. In this context, for each interaction algorithm 122 configured to be implemented in the computing infrastructure 102, the training data 160 may include one or more alternative interaction algorithms 166. An alternative interaction algorithm 166 is generally configured to implement a same or similar functionality as the original interaction algorithm 122. For example, an alternative interaction algorithm 166 may include a different sequence of tasks or processing steps, a different number or steps, different input parameters or a combination thereof as compared to the original interaction algorithm 122 but produces a same or similar result like the original interaction algorithm 122. Essentially, the alternative interaction algorithm 166 comprises a different underlying software code 124 as compared to the original interaction algorithm 122 but that implements a same or similar functionality as the original interaction algorithm 122. This ensures that replacing the original interaction algorithm 122 with an alternative interaction algorithm 166 does not change output of processing the respective data interaction 120. In one embodiment, an alternative interaction algorithm 166 may be a combination of one or more other alternative interaction algorithms 166.

In operation, the interaction data 132 input to the trained AI model 142 may include an identification of the interaction algorithm 122 according to which the respective breached data interaction 120 is being processed. Once the AI model 142 identifies a known threat pattern 162 indicating the interaction algorithm 122 has been compromised, the AI model 142 looks up the transformation configuration 164 associated with the identified threat pattern 162. Upon determining that the transformation configuration 164 specifies replacing the interaction algorithm 122 with an alternative interaction algorithm, the AI model 142, selects an alternative interaction algorithm 166 of the interaction algorithm 122 identified in the interaction data 132 and outputs the alternative interaction algorithm 166 as part of the model output 170 of the AI model 142. Upon obtaining the alternative interaction algorithm 166 as part of the model output 170, security manager 150 reconfigures, in real-time or near real-time during the processing of the data interaction 120, the runtime environment of the data interaction 120 to switch in real time processing of the data interaction in accordance with the alternative interaction algorithm 166 instead of the original interaction algorithm 122. Reconfiguration of the runtime environment almost instantly switches the processing of the data interaction 120 to the alternative interaction algorithm 166.

In one or more embodiments, AI model 142 may be configured to generate one or more alternative interaction algorithms 166 for an original interaction algorithm 122. For example, the metamorphic algorithm 146 of the AI model 142 may be trained based on a transcript associated with each interaction algorithm 122 configured to be implemented in the computing infrastructure 102, wherein the transcript includes information relating to the structure of the respective interaction algorithm 122 such as the processing steps, sequence of processing steps, input parameters, results etc. Based on analyzing the structure of an interaction algorithm 122 as defined in the transcript, the metamorphic algorithm 146 is configured to generate several alternative interaction algorithms 166. The alternative interaction algorithms 166 are then input as part of the training data (e.g., in a second stage training) to train the metamorphic algorithm 146 of the AI model 142 as described above.

In additional or alternative embodiments, the known threat patterns 162 used to train metamorphic algorithm 146 of the AI model 142 include known threat patterns 162 that indicate that the network topology 130 associated with processing the data interaction 120 has been compromised. A compromised network topology 130 may include a breached computing node 104 (e.g., server) that is involved in processing the data interaction 120. Example known threat patterns 162 that indicate that the network topology 130 associated with processing the data interaction 120 has been compromised include, but are not limited to, unexpectedly high (e.g., higher than an expected threshold) CPU utilization, unexpectedly high memory utilization, unexpectedly high node response times, unexpected/unauthorized IP addresses involved in the processing of the data interaction 120 (e.g., transmitting/receiving data) or a combination thereof. When the real-time interaction data 132 associated with a data interaction 120 is input to the trained AI model 142, the trained model 142 may search the interaction data 132 for the known threat patterns 162 that indicate that the network topology 130 (e.g., one or more computing nodes 104) associated with processing the data interaction 120 has been compromised. Upon identifying one or more of the known threat patterns 162, AI model 142 may determine that the network topology 130 (e.g., one or more computing nodes 104) associated with the data interaction 120 has been compromised.

In additional or alternative embodiments, the known threat patterns 162 used to train the metamorphic algorithm 146 of the AI model 142 include known threat patterns 162 that indicate that sensitive data 128 stored at one or more computing nodes 104 has been compromised. This means that a bad actor has somehow gained access to the sensitive data 128. Example known threat patterns 162 that indicate that sensitive data 128 stored at one or more computing nodes 104 has been compromised include, but are not limited to, failed login attempts, logins from unusual locations or device, use of unauthorized (e.g., stolen) login credentials, unauthorized access to restricted data files, unexpected and/or unauthorized modification to data files, alerts from security systems, detection of malware or ransomware, unusual file extensions or file modifications, unusual database queries, and use of uncommon data transfer protocols to exfiltrate data. When the real-time interaction data 132 associated with a data interaction 120 is input to the trained AI model 142, the trained model 142 may search the interaction data 132 for the known threat patterns 162 that indicate that sensitive data 128 has been compromised. Upon identifying one or more of the known threat patterns 162, AI model 142 may determine that the sensitive data 128 has been compromised.

In one or more additional or alternative embodiments, a transformation configuration 164 (e.g., used to train the AI model 142) associated with a known threat pattern 162 indicating a compromised network topology 130 may define that a hardware computing node 104 or a software component that is identified as being breached is to be replaced by a similar hardware computing node 104 or a software component respectively. In this context for each computing node 104 and software component of each network topology 130 implemented in the computing infrastructure 102, the training data 160 includes one or more alternative computing nodes 104 or software components respectively. Each alternative computing node 104 may have a same or similar hardware or software configuration like the original computing node 104. Similarly, each alternative software component may have a same or similar design and configuration as the original software component. Essentially, an alternative computing node 104 can perform all or most tasks that can be performed by the original computing node 104 of which it is an alternative. Similarly, an alternative software component can perform all or most tasks that can be performed by the original software component of which it is an alternative.

In operation, once the AI model 142 identifies a known threat pattern 162 indicating a computing node 104 (or software component), that is part of the network topology 130 implementing a data interaction 120, has been breached, the AI model 142 looks up the transformation configuration 164 associated with the identified threat pattern 162. Upon determining that the transformation configuration 164 specifies replacing the computing node 104 or a software component that is identified as being breached is to be replaced by a similar computing node 104 or a software component respectively, the AI model 142 selects an alternative computing node 104 (or alternative software component) and outputs the alternative computing node 104 (or alternative software component) as topology transformation 168 as part of as part of the model output 170 of the AI model 142. Upon obtaining the alternative computing node 104 (or alternative software component) as part of the model output 170, security manager 150 reconfigures, in real-time or near real-time during the processing of the data interaction 120, the runtime environment of the data interaction 120 to replace the breached computing node 104 (or breached software component) with the alternative computing node 104 (or alternative software component). Reconfiguration of the runtime environment almost instantly switches the breached computing node 104 (or breached software component) with the alternative computing node 104 (or alternative software component). This means that all processing requests originally configured for the breached computing node 104 (or breached software component) are now routed to the alternative computing node 104 (or alternative software component).

In one or more additional or alternative embodiments, a transformation configuration 164 (e.g., used to train the AI model 142) associated with a known threat pattern 162 indicating a compromised piece of sensitive data 128 may define that the breached piece of sensitive data 128 is to be transformed using one or more data transformation methods 172. In this context the training data 160 includes one or more data transformation methods 172, wherein each of the data transformation methods 172 is configured to transform data to avoid theft of the data. The data transformation methods 172 may include, but are not limited to, a data encryption method that encrypts the data, a data obfuscation method that alters at least a portion of the data to avoid unauthorized access of the data, and data redundancy method that copies the data to several computing nodes 104 to allow for data integrity checks.

In operation, once the AI model 142 identifies a known threat pattern 162 indicating that the piece of sensitive data 128 has been breached, the AI model 142 looks up the transformation configuration 164 associated with the identified threat pattern 162. Upon determining that the transformation configuration 164 specifies that the breached piece of sensitive data 128 is to be transformed using one or more data transformation methods 172, AI model 142 selects one or more data transformation methods 172 and outputs the selected data transformation methods 172 as part of the model output 170 of the AI model 142. Upon obtaining the one or more data transformation methods 172 as part of the model output 170, security manager 150 reconfigures, in real-time or near real-time during the processing of the data interaction 120, the runtime environment of the data interaction 120 to transform the breached piece of sensitive data 128 using the one or more data transformation methods 172. For example, the sensitive data 128 may be encrypted based on a selected data encryption method. In another example, at least a portion of the sensitive data 128 may be obfuscated using a selected data obfuscating method. In another example, the sensitive data 128 may be copied to one or more other computing nodes 104 in accordance with a selected data redundancy method. This allows the system to detect any unauthorized changes to the sensitive data 128 by comparing all the copies of sensitive data 128 stored at different computing nodes 104.

In one or more embodiments, after the runtime configuration associated with a breached data interaction 120 has been modified (e.g., after transformation of the interaction algorithm 122, network topology 130, sensitive data 128 or a combination thereof) security manager 150 may continue to feedback performance data 134 to the AI model 142 so that the AI model 142 can learn whether the implemented metamorphic transformation of the runtime environment has stopped the detected data breach and adjust the metamorphic configuration accordingly. For example, if the performance data 134 still indicates that the data breach is in progress, the AI model 142 may perform another iteration of metamorphic transformations as described above. The additional iterations of the metamorphic transformations may continue until the performance data 134 indicates that no data breach is in progress.

FIG. 2 illustrates an example system for implementing metamorphic transformations in a computing infrastructure 102, in accordance with certain embodiments of the present disclosure. Method 200 may be performed by the security manager 150 shown in FIG. 1.

At operation 202, security manager 150 electronically receives data (e.g., interaction data 132) associated with processing a first data interaction 120 in a computing system (e.g., computing infrastructure 102).

As described above a data interaction 120 may be initiated by a user 106 or may be based on a machine-initiated request. Security manager 150 may be configured to detect that a data breach has occurred in relation to a data interaction 120 being processed in the computing infrastructure 102 or a portion thereof, based on monitoring performance of the computing infrastructure 102 or the potion thereof. In this context, security manager 150 may be configured to monitor several metrics (e.g., interaction data 132) associated with processing of a data interaction 120 in the computing infrastructure 102 to determine whether a data breach has occurred in relation to the data interaction 120. In this context, security manager 150 may have access to interaction data 132 associated with data interactions 120 being processed by computing nodes 104 of the computing infrastructure 102. Interaction data 132 associated with a particular data interaction 120 may include performance data 134 indicating performance of various hardware components (e.g., computing nodes such as servers, user devices, network devices, etc.) and software components (e.g., operating systems, customized software etc.) used to process the particular data interaction 120.

At operation 204, security manager 150 determines, based on the data (e.g., interaction data 132), that a data/security breach has occurred in the computing system (e.g., computing infrastructure 102).

As described above, security manager 150 may be configured to perform a threat assessment 136 for each data interaction 120 being processed in the computing infrastructure 102 to at least determine, in real-time, whether a data breach has occurred in relation to a data interaction 120 being processed in the computing infrastructure 102. The threat assessment 136 performed by security manager 150 may include analyzing at least the interaction data 132 associated with a data interaction 120 to determine whether a data breach has occurred in relation to the data interaction 120. As part of the threat assessment 136, security manager 150 may be configured to identify certain indicators of a data breach or a potential data breach in the interaction data 132 associated with a data interaction 120.

At operation 206, if a security breach not detected method 200 ends here. On the other hand, if a security breach is detected, method proceeds to operation 208 where in response to determining that the security breach has occurred, security manager 150 electronically generates a first transformation trigger 140.

As described above, once a determination of data breach has been made in relation to a data interaction 120, security manager 150 may be configured to generate a transformation trigger 140 to initiate metamorphic transformation of the runtime/execution environment of the data interaction.

At operation 210, security manager 150 trains an AI algorithm 144 associated with an AI model 142 to at least determine that a first interaction algorithm 122 associated with processing the data interaction 120 is breached and determine an alternative to the first interaction algorithm 122.

As described above, in response to detecting that a transformation trigger 140 has been generated in relation to a data interaction, security manager 150 may be configured to dynamically transform (e.g., change, adjust and/or replace), in real time, any portion of the runtime environment associated with the data interaction 120 including the interaction algorithm 122, network topology 130, sensitive data 128, or combination thereof. In this context, security manager 150 may be configured to employ a trained AI model 142 to determine which one or more components (e.g., interaction algorithm 122, network topology 130, sensitive data 128) of the runtime environment is to be metamorphically transformed and how the metamorphic transformation is to be implemented. In one embodiment, the AI model 142 may employ a metamorphic algorithm 146 to make these determinations.

In this context, security manager 150 may be configured to train the metamorphic algorithm 146 of the AI model 142 to detect which one or more components (e.g., interaction algorithm 122, network topology 130, sensitive data 128) of the runtime environment has been compromised. For example, training data 160 used to train the metamorphic algorithm 146 of the AI model 142 includes known threat patterns 162 that indicate which component components (e.g., interaction algorithm 122, network topology 130, sensitive data 128) of the runtime environment has been compromised. In one embodiment, the known threat patterns 162 used to train the metamorphic algorithm 146 of the AI model 142 include known threat patterns 162 that indicate that the interaction algorithm 122 associated with the data interaction 120 has been compromised or breached. This essentially may mean that a bad actor has found a vulnerability in the interaction algorithm 122 and is attempting to breach or has already breached the computing network using this vulnerability. Example, known threat patterns 162 that indicate that the interaction algorithm 122 associated with the data interaction 120 has been compromised include, but are not limited to, incorrect or unexpected results, anomalies in log entries, unusual access/login attempts, unauthorized data alteration, unexpected change in source code (e.g., software code 124) of the interaction algorithm 122, and antivirus intrusion alerts.

At operation 212, in response to detecting the transformation trigger 140, security manager 150 inputs to the trained AI model 142 at least a portion of the data (e.g., interaction data 132) associated with the processing of the first data interaction 120.

As described above, once the metamorphic algorithm 146 of the AI model 142 is trained using the known threat patterns 162, security manager 150 may input to the trained AI model 142 real-time interaction data 132 associated with a data interaction 120 actively processing in the computing infrastructure 102. In one embodiment, security manager 150 may initiate this process in response to detecting that the transformation trigger 140 has been generated.

At operation 214, security manager 150 executes the AI algorithm 144 associated with the AI model 142 to perform operations 214A, 214B and 214C.

At operation 214A, security manager 150 executes the AI algorithm 144 to determine, based on the portion of the data (e.g., interaction data 132) associated with processing the first data interaction 120, that the first interaction algorithm 122 associated with processing the first data interaction 120 is breached.

As described above, the trained AI model 142 may search the interaction data 132 for the known threat patterns 162 that indicate that the interaction algorithm 122 associated with the data interaction 120 has been compromised. Upon identifying one or more of the known threat patterns 162, AI model 142 may determine that the interaction algorithm 122 associated with the data interaction 120 has been compromised.

At operation 214B, in response to determining that the first interaction algorithm 122 is breached, security manager 150 executes the AI algorithm 144 to select a first alternative interaction algorithm 166 from the plurality of alternative interaction algorithms 166.

At operation 214C, security manager 150 executes the AI algorithm 144 to output the selected first alternative interaction algorithm 166 as part of model output 170 of the AI model 142.

As described above, once the AI model 142 identifies that one or more components (e.g., interaction algorithm 122, network topology 130, sensitive data 128) of the runtime environment associated with the data interaction 120 has been compromised, the AI model 142 may determine how to metamorphically transform the one or more components to stop the data breach from progressing and avoid further damage as a result of the data breach. In this context, in an additional or alternative embodiment, security manager 150 may be configured to train the metamorphic algorithm 146 of the AI model 142 to determine how one or more components (e.g., interaction algorithm 122, network topology 130, sensitive data 128) of the runtime environment is to be metamorphically transformed. Training data 160 used to train the metamorphic algorithm 146 of the AI model 142 for this purpose may include a transformation configuration 164 associated with each known threat pattern 162, wherein each transformation configuration 164 defines how one or more components (e.g., interaction algorithm 122, network topology 130, sensitive data 128) of the runtime environment are to be transformed. For example, a transformation configuration 164 associated with a known threat pattern 162 indicating a compromised interaction algorithm 122 may define that the interaction algorithm 122 is to be modified or replaced with an alternative interaction algorithm 166. In this context, for each interaction algorithm 122 configured to be implemented in the computing infrastructure 102, the training data 160 may include one or more alternative interaction algorithms 166. An alternative interaction algorithm 166 is generally configured to implement a same or similar functionality as the original interaction algorithm 122. For example, an alternative interaction algorithm 166 may include a different sequence of tasks or processing steps, a different number or steps, different input parameters or a combination thereof as compared to the original interaction algorithm 122 but produces a same or similar result like the original interaction algorithm 122. Essentially, the alternative interaction algorithm 166 comprises a different underlying software code 124 as compared to the original interaction algorithm 122 but that implements a same or similar functionality as the original interaction algorithm 122. This ensures that replacing the original interaction algorithm 122 with an alternative interaction algorithm 166 does not change output of processing the respective data interaction 120. In one embodiment, an alternative interaction algorithm 166 may be a combination of one or more other alternative interaction algorithms 166.

In operation, the interaction data 132 input to the trained AI model 142 may include an identification of the interaction algorithm 122 according to which the respective breached data interaction 120 is being processed. Once the AI model 142 identifies a known threat pattern 162 indicating the interaction algorithm 122 has been compromised, the AI model 142 looks up the transformation configuration 164 associated with the identified threat pattern 162. Upon determining that the transformation configuration 164 specifies replacing the interaction algorithm 122 with an alternative interaction algorithm, the AI model 142, selects an alternative interaction algorithm 166 of the interaction algorithm 122 identified in the interaction data 132 and outputs the alternative interaction algorithm 166 as part of the model output 170 of the AI model 142.

At operation 216, security manager 150 switches, in real-time or near real-time during the processing of the first data interaction 120, to processing of the first data interaction 120 in accordance with the first alternative interaction algorithm 166 instead of the first interaction algorithm 122.

As described above, upon obtaining the alternative interaction algorithm 166 as part of the model output 170, security manager 150 reconfigures, in real-time or near real-time during the processing of the data interaction 120, the runtime environment of the data interaction 120 to switch in real time processing of the data interaction in accordance with the alternative interaction algorithm 166 instead of the original interaction algorithm 122. Reconfiguration of the runtime environment almost instantly switches the processing of the data interaction 120 to the alternative interaction algorithm 166.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a memory that stores an Artificial Intelligence (AI) model; and
a processor communicatively coupled to the AI model and configured to:
electronically receive data associated with processing of a first data interaction in a computing system;
determine, based on the data, that a security breach has occurred in the computing system;
in response to determining that the security breach has occurred, electronically generate a first transformation trigger;
train an AI algorithm associated with the AI model to at least determine that a first interaction algorithm associated with processing the first data interaction is breached and determine an alternative to the first interaction algorithm, wherein training data used to train the AI algorithm at least comprises:
a plurality of known threat patterns, wherein each known threat pattern includes one or more known metrics that indicate that the first interaction algorithm has been breached; and
a plurality of alternative interaction algorithms associated with the first interaction algorithm, wherein each alternative interaction algorithm is configured to implement a same or similar functionality as the first interaction algorithm;
in response to detecting the first transformation trigger, input to the AI model at least a portion of the data associated with the processing of the first data interaction;
execute the AI algorithm associated with the AI model to:
determine, based on the portion of the data associated with processing the first data interaction, that the first interaction algorithm associated with processing the first data interaction is breached, wherein the first interaction algorithm is configured to process the first data interaction, wherein the determining comprises:
identifying in the interaction data a first known threat pattern that indicates that the first interaction algorithm has been breached; and
in response to identifying the first known threat pattern, determining that the first interaction algorithm has been breached;
in response to determining that the first interaction algorithm is breached, select a first alternative interaction algorithm from the plurality of alternative interaction algorithms; and
output the first alternative interaction algorithm as a result of the AI model; and
switch, in real-time or near real-time during the processing of the first data interaction, to processing of the first data interaction in accordance with the first alternative interaction algorithm instead of the first interaction algorithm.

2. The system of claim 1, wherein each of the first interaction algorithm and the plurality of alternative interaction algorithms comprises a different software code that implements the same or similar functionality.

3. The system of claim 1, wherein the first alternative interaction algorithm is a combination of two or more alternative interaction algorithms.

4. The system of claim 1, wherein the processor is further configured to:
execute the AI algorithm associated with the AI model to:
determine, based on the portion of the data associated with processing the data interaction, that sensitive data to be accessed during processing of the first data interaction has been breached;
in response to determining that the sensitive data has been breached, determine one or more data transformation methods that transform the sensitive data, wherein each data transformation method transforms the sensitive data to avoid theft of the sensitive data; and
output the one or more data transformation methods as part of the result of the AI model; and
transform the sensitive data in real-time or near real-time based on the one or more data transformation methods during the processing of the first data interaction.

5. The system of claim 4, wherein the one or more data transformation methods comprise a data encryption method that encrypts the sensitive data.

6. The system of claim 4, wherein the one or more data transformation methods comprise a data obfuscation method that alters at least a portion of the sensitive data to avoid unauthorized access of the sensitive data.

7. The system of claim 1, wherein the processor is further configured to:
execute the AI algorithm associated with the AI model to:
determine, based on the portion of the data associated with processing the data interaction, that a first computing node that is to perform a portion of the processing of the first data interaction has been breached;
in response to determining that the first computing node has been breached, determine an alternative second computing node that can perform the portion of the processing configured to be performed by the first computing node; and
output an identity of the second computing node as part of the result of the AI model; and
configure, in real-time or near real-time during the processing of the first data interaction, the second computing node to process the portion of the processing instead of the first computing node.

8. A method comprising:
electronically receiving data associated with processing of a first data interaction in a computing system;
determining, based on the data, that a security breach has occurred in the computing system;
in response to determining that the security breach has occurred, electronically generating a first transformation trigger;
training an Artificial Intelligence (AI) algorithm associated with an AI model to at least determine that a first interaction algorithm associated with processing the first data interaction is breached and determine an alternative to the first interaction algorithm, wherein training data used to train the AI algorithm at least comprises:
a plurality of known threat patterns, wherein each known threat pattern includes one or more known metrics that indicate that the first interaction algorithm has been breached; and
a plurality of alternative interaction algorithms associated with the first interaction algorithm, wherein each alternative interaction algorithm is configured to implement a same or similar functionality as the first interaction algorithm;
in response to detecting the first transformation trigger, inputting to the AI model at least a portion of the data associated with the processing of the first data interaction;
executing the AI algorithm associated with the AI model to:
determine, based on the portion of the data associated with processing the first data interaction, that the first interaction algorithm associated with processing the first data interaction is breached, wherein the first interaction algorithm is configured to process the first data interaction, wherein the determining comprises:
identifying in the interaction data a first known threat pattern that indicates that the first interaction algorithm has been breached; and
in response to identifying the first known threat pattern, determining that the first interaction algorithm has been breached;
in response to determining that the first interaction algorithm is breached, select a first alternative interaction algorithm from the plurality of alternative interaction algorithms; and
output the first alternative interaction algorithm as a result of the AI model; and
switching, in real-time or near real-time during the processing of the first data interaction, to processing of the first data interaction in accordance with the first alternative interaction algorithm instead of the first interaction algorithm.

9. The method of claim 8, wherein each of the first interaction algorithm and the plurality of alternative interaction algorithms comprises a different software code that implements the same or similar functionality.

10. The method of claim 8, wherein the first alternative interaction algorithm is a combination of two or more alternative interaction algorithms.

11. The method of claim 8, further comprising:
executing the AI algorithm associated with the AI model to:
determine, based on the portion of the data associated with processing the data interaction, that sensitive data to be accessed during processing of the first data interaction has been breached;
in response to determining that the sensitive data has been breached, determine one or more data transformation methods that transform the sensitive data, wherein each data transformation method transforms the sensitive data to avoid theft of the sensitive data; and
output the one or more data transformation methods as part of the result of the AI model; and
transforming the sensitive data in real-time or near real-time based on the one or more data transformation methods during the processing of the first data interaction.

12. The method of claim 11, wherein the one or more data transformation methods comprise a data encryption method that encrypts the sensitive data.

13. The method of claim 11, wherein the one or more data transformation methods comprise a data obfuscation method that alters at least a portion of the sensitive data to avoid unauthorized access of the sensitive data.

14. The method of claim 8, further comprising:
executing the AI algorithm associated with the AI model to:
determine, based on the portion of the data associated with processing the data interaction, that a first computing node that is to perform a portion of the processing of the first data interaction has been breached;
in response to determining that the first computing node has been breached, determine an alternative second computing node that can perform the portion of the processing configured to be performed by the first computing node; and
output an identity of the second computing node as part of the result of the AI model; and
configure, in real-time or near real-time during the processing of the first data interaction, the second computing node to process the portion of the processing instead of the first computing node.

15. A non-transitory computer-readable medium storing instructions that when executed by a processor causes the processor to:
electronically receive data associated with processing of a first data interaction in a computing system;
determine, based on the data, that a security breach has occurred in the computing system;
in response to determining that the security breach has occurred, electronically generate a first transformation trigger;
train an Artificial Intelligence (AI) algorithm associated with an AI model to at least determine that a first interaction algorithm associated with processing the first data interaction is breached and determine an alternative to the first interaction algorithm, wherein training data used to train the AI algorithm at least comprises:
a plurality of known threat patterns, wherein each known threat pattern includes one or more known metrics that indicate that the first interaction algorithm has been breached; and
a plurality of alternative interaction algorithms associated with the first interaction algorithm, wherein each alternative interaction algorithm is configured to implement a same or similar functionality as the first interaction algorithm;
in response to detecting the first transformation trigger, input to the AI model at least a portion of the data associated with the processing of the first data interaction;
execute the AI algorithm associated with the AI model to:
determine, based on the portion of the data associated with processing the first data interaction, that the first interaction algorithm associated with processing the first data interaction is breached, wherein the first interaction algorithm is configured to process the first data interaction, wherein the determining comprises:
identifying in the interaction data a first known threat pattern that indicates that the first interaction algorithm has been breached; and
in response to identifying the first known threat pattern, determining that the first interaction algorithm has been breached;
in response to determining that the first interaction algorithm is breached, select a first alternative interaction algorithm from the plurality of alternative interaction algorithms; and
output the first alternative interaction algorithm as a result of the AI model; and
switch, in real-time or near real-time during the processing of the first data interaction, to processing of the first data interaction in accordance with the first alternative interaction algorithm instead of the first interaction algorithm.

16. The non-transitory computer-readable medium of claim 15, wherein each of the first interaction algorithm and the plurality of alternative interaction algorithms comprises a different software code that implements the same or similar functionality.

17. The non-transitory computer-readable medium of claim 15, wherein the first alternative interaction algorithm is a combination of two or more alternative interaction algorithms.

18. The non-transitory computer-readable medium of claim 15, wherein the instructions further cause the processor to:
execute the AI algorithm associated with the AI model to:
determine, based on the portion of the data associated with processing the data interaction, that sensitive data to be accessed during processing of the first data interaction has been breached;
in response to determining that the sensitive data has been breached, determine one or more data transformation methods that transform the sensitive data, wherein each data transformation method transforms the sensitive data to avoid theft of the sensitive data; and
output the one or more data transformation methods as part of the result of the AI model; and
transform the sensitive data in real-time or near real-time based on the one or more data transformation methods during the processing of the first data interaction.

19. The non-transitory computer-readable medium of claim 18, wherein the one or more data transformation methods comprise a data obfuscation method that alters at least a portion of the sensitive data to avoid unauthorized access of the sensitive data.

20. The non-transitory computer-readable medium of claim 15, wherein the instructions further cause the processor to:
execute the AI algorithm associated with the AI model to:
determine, based on the portion of the data associated with processing the data interaction, that a first computing node that is to perform a portion of the processing of the first data interaction has been breached;
in response to determining that the first computing node has been breached, determine an alternative second computing node that can perform the portion of the processing configured to be performed by the first computing node; and
output an identity of the second computing node as part of the result of the AI model; and
configure, in real-time or near real-time during the processing of the first data interaction, the second computing node to process the portion of the processing instead of the first computing node.
